(19) United States
(12) Patent Application Publication
(10) Pub. No.: US 2003/0170083 A1
(43) Pub. Date: Sep. 11, 2003

(54) Centering and fastening device

(75) Inventor: Antonio Carlos Gottifredi, Buenos Aires (AR)

Correspondence Address: REED SMITH CROSBY HEAFEY LLP, 1901 AVENUE OF THE STARS, SUITE 700, LOS ANGELES, CA, 90067, US

(73) Assignee: Vince Bargados

(21) Appl. No.: 10/280,500

(22) Filed: Oct. 25, 2002

(30) Foreign Application Priority Data
Mar. 10, 2002 (AR) AR 02 01 01703

(51) Int. Cl. B23B 41/00; B23B 51/00

(52) U.S. Cl. 408/83.5

(57) ABSTRACT

An improved internal diameter milling machine for centering and milling valve seats in internal combustion engines and the like. An hydropneumatic system suspends a hemispherical guide or bearing concentric to the headstock-screw lead screw of the inventive milling machine. This suspension allows the lead screw and attached cutting tool to move in a pendular manner in response to 90° horizontal movements of the work piece. The pendular motion results in the rapid cutting of a smooth and concentric valve seat within about two minutes in a virtually automatic manner.

This Application claims priority of Argentine Application 02 01 01703, filed May 10, 2002, which Application is incorporated herein by reference.

### BACKGROUND OF THE INVENTION

1. Area of the Art

The present invention is related to machine tools in general and more specifically to a device for centering and concentric milling of valve seats in internal combustion engines.

2. Description of the Prior Art

The practical needs that motivated the submitter to create this invention are the needs to solve a currently existing problem, such as the correct Internal Diameter milling and concentricity required for the valve seats in cylinder heads and/or blocks of internal combustion engines.

As it is already known, the Internal Diameter milling with the existing machines offered serious technical set up problems because the valve seats, in general, are incorrectly aligned with their respective valve stem guides, thus forcing an operator to make difficult corrections. Likewise the deformations between the valve seat and its respective stem guide produce problems that are difficult to deal with when trying to repair these deformations.

To solve this type of difficulties, until now certain complex set ups were used to get the appropriate finishing and alignment of these seats, but they demanded too much time, spending more than 10 (ten) minutes for each unit.

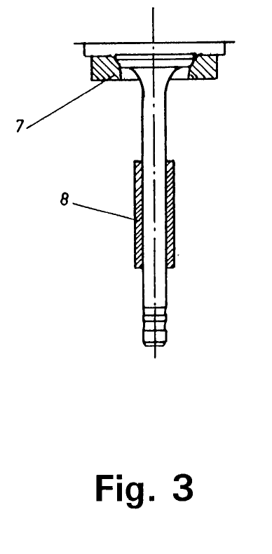

The inventive apparatus is ideal to do away with these difficulties, because it solves all the outlined problems. It allows perfect alignment and centering of the seat in regards to its stem guide. The tasks are performed very quickly and almost automatically, to the extent that the entire operation takes around 2 (two) minutes, with great precision and totally freedom from. A perfect alignment and centering of the seat regarding its stem is attained, and, as shown in FIG. 3, the Seat to be machined 7 must be concentric with the stem guide 8.

To clearly understand the present invention, and to put its fundamental concept easily into practice, a precise description of the preferred forms will be provided, giving reference to the attached drawings as merely illustrative examples, but in no way limiting the Invention.

### SUMMARY OF THE INVENTION

Centering of and concentric milling of valve seats in an internal combustion engine are time consuming jobs requiring a skilled machinist or specialized numerical control milling machines. The present invention is an improved internal diameter-milling machine for centering and milling valve seats. The headstock-lead screw of the milling machine is constructed so that it passes through the center of and is connected to a hemispherical guide or bearing that rests in a concave hemispherical depression. An hydropneumatic system suspends the hemispherical guide in an essentially friction-free manner above the concavity on a film of oil. A work piece (e.g., an engine block) is suspended on an inferior platen that can be freely translated in an x-y manner in a horizontal plan. The work piece is translated so that the headstock-lead screw or a “feeler” extension thereto indicates that the lead screw is exactly centered in the valve stem passage. Then the hydropneumatic suspension allows the lead screw and an attached cutting tool to move in a pendular manner (i.e., swing back and forth like a pendulum around a vertical axis) in response to 90° horizontal movements of the work piece. The pendular motion results in the rapid cutting of a smooth and concentric valve seat within about two minutes in a virtually automatic manner in response to simple x-y movement of the work piece.

### DESCRIPTION OF THE FIGS.

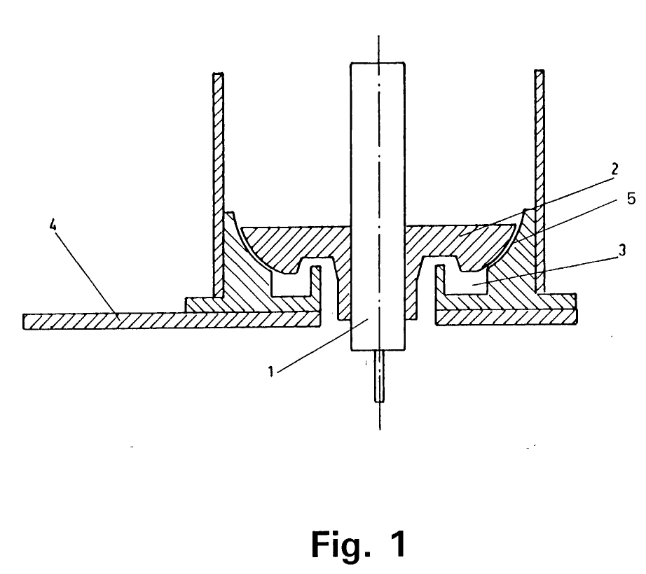

FIG. 1 shows a perspective of the centering apparatus, which is the object of the invention, wherein details of its construction can be clearly seen.

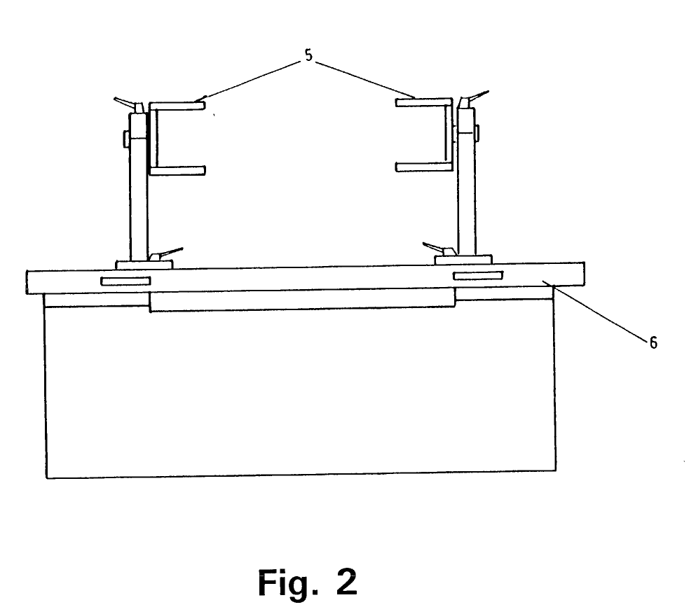

FIG. 2 shows a view of the inferior floating platen, that complements the apparatus, allows fastening the cylinder lids and makes the final adjustment before the definitive milling of the valve seat.

FIG. 3 shows a valve with a valve seat and valve stem guide.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a centering and fastening device for internal milling of valve seats and the like.

Essentially, and in the embodiment illustrated in FIG. 1, the invention consists of a headstock-lead screw 1 installed on a hemispherical guide bearing 2 that and allow a pendular or a pendulum-type motion (i.e., side to side motion) when supported by pressurized hydraulic oil in hydropneumatic channels 3. The hydropneumatic channels 3 are connected to an hydraulic oil reservoir (not shown) which is pressurized by compressed air to force the oil in the channels 3; hydraulic seals (not shown) prevent leakage of the oil. The pressure of the compressed air is regulated to “float” the hemispherical bearing 2 in an essentially friction-free manner over and in relation to a complementary hemispherical concavity 5. The hydropneumatic system 3 is mounted on an overhead floating platen 4 that has the same longitudinal-transversal motion (e.g., x-y motion) of any milling or similar machine.

The mentioned headstock-lead screw 1 has the same travel of the machine tool (not illustrated) that enables a centered valve seat to be machined. The apparatus of FIG. 1 is used together with an inferior floating platen 6 shown in FIG. 2. The piece to be machined (e.g., an engine block) is mounted in supports 5. The functional relationship between the different described elements is very simple and easily follows from what has been illustrated. The valve seat is centered by means of cooperation between the headstock-lead screw 1 and the inferior platen 6 as is well understood by one of ordinary skill in the art. Once the lead screw 1 is centered properly, a cutting tool is attached and the actual displacement (not illustrated) for milling the seat is produced by manually moving the nascent valve seat in a perfect square (as traced by the stem guide 8 (FIG. 3). It will be appreciated that the distance by which the valve seat is displaced in a horizontal plane will control the diameter of the new valve seat. This causes a rotating cutting tool mounted on the headstock-lead screw 1 to contact and cut the valve seat 7. However, the hydraulic suspension caused by hydropneumatic channels 3 allows the cutting tool to swing freely according to the hemispherical guide 2 so that the square motion of the valve seat 7 is transformed into a symmetrical round motion an a perfect round and centered valve seat is cut. Essentially, the concave suspending surface 5 becomes “mirrored” in the newly cut valve seat.

The speed with which milling the seat can be performed can be readily noticed, and also carrying out the operation is almost automatic, according to what was explained in the previous paragraphs. It will also be apparent that the present invention can be applied to cutting a number of different concentric seats for use in valves other than those in engines as well as other applications.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

1. A Centering and Fastening Device, that can be applied to milling and/or similar machines, that can be installed between a headstock-lead screw and an inferior fastening platen CHARACTERIZED by a system that suspends a hemispherical guide in relation to a hemispherical concavity to enable a pendular motion of the headstock-lead screw, and an inferior fastening floating platen to attach and move a work piece to be milled.

2. The centering and fastening device; according to claim 1, wherein the suspension system is hydropneumatic.

3. The centering and fastening device; according to claim 1, wherein horizontal translation of the work piece in mutually perpendicular directions is converted by the suspension system into even concentric cutting about a central axis of the headstock-lead screw.

4. A centering and fastening device comprising:
a headstock-lead screw;
a hemisphere surrounding and attached to said lead screw;
a concave hemispherical surface upon which the hemisphere rests; and
a suspension system for suspending said hemisphere for essentially friction-free rotation and pendular motion in relation to the concave hemispherical surface.

5. The centering and fastening device according to claim 4, wherein the suspension system includes channels that are filled with a pressurized fluid.

6. The centering and fastening device according to claim 4, wherein the fluid is pressurized by a gas.

7. A method for machining a concentric circular valve seat comprising the steps of:
providing a milling machine having a lead screw supported by a hemispherical guide suspension system that enables pendular motion of the lead screw;
moving a work piece so that the lead screw is located on a central axis of a valve seat to be cut;
activating the suspension system to enable pendular motion of the lead screw; and
moving the work piece in mutually perpendicular horizontal 11 directions, thereby causing pendular motion of the lead screw and resulting in cutting a circular valve seat concentric to the central axis.
